(19) United States
(12) Patent Application Publication
(10) Pub. No.: US 2026/0128208 A1
(43) Pub. Date: May 7, 2026

(54) ELECTRONIC DEVICE

(71) Applicant: Shenzhen Sunlord Electronics Co., Ltd., Shenzhen (CN)

(72) Inventors: Zhongdong WU, Shenzhen (CN); Jieyong QIN, Shenzhen (CN); Lirui WANG, Shenzhen (CN)

(73) Assignee: Shenzhen Sunlord Electronics Co., Ltd., Shenzhen (CN)

(21) Appl. No.: 19/435,578

(22) Filed: Dec. 29, 2025

Related U.S. Application Data
(63) Continuation of application No. PCT/CN2023/105107, filed on Jun. 30, 2023.

(51) Int. Cl. H01F 27/29; H01F 27/28; H01F 27/32

(52) U.S. Cl. CPC H01F 27/29; H01F 27/2804; H01F 27/32

(57) ABSTRACT

An electronic device includes a blank body provided with an insulating material, a conductive coil located within the blank body, and a first terminal and a second terminal exposed out of a surface of the blank body. The blank body has a top surface, a bottom surface, a first side surface, a second side surface, a front surface, and a back surface. The top surface is parallel to the bottom surface, the first side surface is parallel to the second side surface, and the front surface is parallel to the back surface. A plane parallel to the top surface and the bottom surface, a plane parallel to the first side surface and the second side surface, and a plane parallel to the front surface and the back surface are perpendicular to each other.

### CROSS-REFERENCE TO RELATED APPLICATIONS

This application is a continuation of International Application No. PCT/CN2023/105107, filed on Jun. 30, 2023, the content of which is incorporated herein by reference in its entirety.

### TECHNICAL FIELD

The present application relates to the field of electronic component technology, and particularly, to an inductor component.

### BACKGROUND

Inductors are common electronic components whose main function is to store and release magnetic energy. In modern electronic technology, inductors are widely used in various fields, such as communications, computers, automotive electronics, etc. However, in actual production, due to the limitations of manufacturing processes and materials, there are certain problems with the performance and stability of inductor products.

Traditionally, in order to improve the magnetic conductivity and to reduce the DC resistance value in inductors, manufacturers usually choose to make breakthroughs in materials and use materials with high conductivity. However, this approach may lead to issues such as long development cycles and high costs for inductor products. The existing inductor coil has a thickness-to-width ratio (the ratio of the thickness to the width in the cross section) that ranges below 0.5, which may lead to poor performance of inductor products at high frequencies, and issues such as magnetic leakage, large fluctuations an instability in inductance and so on being prone to occur.

It should be noted that the information disclosed in the above technical background section is only used for understanding the background of the present application, and therefore may include information that does not constitute prior art known to those ordinary skills in the art.

### SUMMARY

Therefore, the object of the present application is to provide an electronic device capable of increasing the Q value and improving the stability of inductance value.

To achieve the above object, the present application adopts the following technical solutions.

An electronic device includes a blank with an insulating material, a conductive coil within the blank, and a first terminal and a second terminal exposed to a surface of the blank, wherein the blank has a top surface, a bottom surface, a first lateral surface, a second lateral surface, a front surface and a back surface, wherein the top surface is parallel to the bottom surface, the first lateral surface is parallel to the second lateral surface, the front surface is parallel to the back surface, and a plane parallel to the top surface and the bottom surface, a plane parallel to the first lateral surface and the second lateral surface, and a plane parallel to the front surface and the back surface are mutually perpendicular, wherein external dimensions of the top surface, the bottom surface, the first lateral surface, the second lateral surface, the front surface and the back surface are of 0402 or below; wherein a thickness-to-width ratio of at least one electrode layer of the conductive coil is 0.5 or more, and a cross section of the at least one electrode layer has a width of at least 15 μm and at most 30 μm, and a thickness of at least 15 μm and at most 40 μm.

Further, the conductive coil has a plurality of electrode layers, an electrode layer of the conductive coil correspondingly connected to the first terminal is a lead-in layer electrode, an electrode layer of the conductive coil correspondingly connected to the second terminal is a lead-out layer electrode, an electrode layer of the conductive coil located between the lead-in layer electrode and the lead-out layer electrode is an intermediate layer electrode, and respective electrode layers are connected through conductive paths between layers.

Further, the thickness-to-width ratio of the at least one electrode layer is 0.6 or more.

Further, the thickness-to-width ratio of the at least one electrode layer is 2.0 or less.

Further, the thickness-to-width ratio of the at least one electrode layer is 1.0 or less.

Further, the cross section of the electrode layer of the conductive coil has a rectangular, trapezoidal, parallelogram or elliptical shape, and the thickness-to-width ratio of the electrode layer is a ratio of a maximum thickness of the cross section of the electrode layer to a maximum width of the cross section of the electrode layer.

Further, the electronic device is a laminated chip composite inductor device.

Further, the at least one electrode layer is an intermediate layer electrode layer.

Further, the conductive coil is formed in a stack provided with a plurality of electrode layers, and the plurality of electrode layers form a spiral conductive coil by forming connections in a state of overlapping with each other when viewed from a stacking direction.

The present application has the following beneficial effects.

In the present application, the thickness-to-width ratios of the laminated electrode layers of the inductor coil are set to be 0.5 or more, which can increase the quality factor Q value of the inductor product by 10% or more without reducing the inductance value, so that the inductor product can do work more effectively and the sensitivity to the cross-sectional width of the coil is reduce, that is, the electrical stability of the inductor product during the change in the cross-sectional width of the coil is improved, the failure rate caused by the electrical property difference between products is reduced, and the using experience of the product at the application end is improved.

### BRIEF DESCRIPTION OF THE DRAWINGS

FIG. 1 is a front view of the structure of an electronic device according to an embodiment of the present application.

FIG. 2 is a left side view of the structure of an electronic device according to an embodiment of the present application.

FIGS. 3a to 3d are schematic views of inductor products with a thickness-to-width ratio according to embodiments of the present application, the cross sections of the coils of the inductor products have a rectangular shape, a trapezoidal shape, a parallelogram shape and an elliptical shape, respectively.

### DETAILED DESCRIPTION OF THE EMBODIMENTS

The present application will be further described below with reference to the accompanying drawings and in combination with preferred embodiments. It should be noted that the embodiments and features in the embodiments of the present application can be combined with each other without conflict.

The composition of an inductor component is mainly divided into three parts: a blank (frame body) that serves as insulation, a coil that serves as inductance, and a terminal connected with the outside, and the terminal of the product need to bear the physical connection with the outside and forms a loop with the circuit for conduction. Under the premise of certain materials, the structural design of the coil has a decisive impact on the performance of the inductor, among which the width, the thickness, and the thickness-to-width ratio (the cross-sectional thickness/the cross-sectional width of the coil) of the coil cross-sectional area are the most critical parameters.

In metric 0402 size inductor products with an external dimension in which a length ranges from 0.38 to 0.42 mm, a width ranges from 0.18 to 0.22 mm and a height ranges from 0.18 to 0.22 mm, the mainstream structural design parameters are that the coil cross-sectional area has a width in a range of 25-45 μm and a thickness in range of 6-11 μm, and the thickness to width ratio of the coil cross-sectional area is generally less than 0.5. In metric 0201 size inductor products with an external dimension in which a length ranges from 0.23 to 0.27 mm, a width ranges from 0.105 to 0.145 mm and a height ranges from 0.18 to 0.22 mm, the mainstream structural design parameters are that the coil cross-sectional area has a width in a range of 18-35 μm, and a thickness in a range of 6-9 μm, and the thickness to width ratio of the coil cross-sectional area is generally less than 0.5.

The embodiment of the present application is, in the inductor products of the metric 0402 size and below, i.e., in inductor products have a length of 0.42 mm or less, a width of 0.22 mm or less and a heigh of 0.22 mm or less, or in inductor products with even smaller external dimensions, to design the thickness-to-width ratio of the coil cross-sectional area to be 0.5 or more, and preferably to be 2.0 or less, thereby improving the Q value of the inductor product and reducing the sensitivity to the width of the coil cross section, that is, improving the electrical stability of the inductor product during the change in the cross-sectional width of the coil. In the embodiment of the present application, in the structural design of which the cross section of the coil has a width in the range of 15 to 20 μm, and a thickness in the range of 9 to 15 μm, and the minimum cross-sectional area is 135 μm² (considering the resistance value of the inductor coil as small as possible), the thickness-to-width ratio of the coil cross-sectional area is designed to be 0.5 or more, the Q value of products with the same inductance value can be increase by 10% or more, and when the coil cross-sectional width tolerance varies by ±2 μm, the electrical CPK (process capability index) can be maintained at 1.33 and more, improving the user experience at the application end.

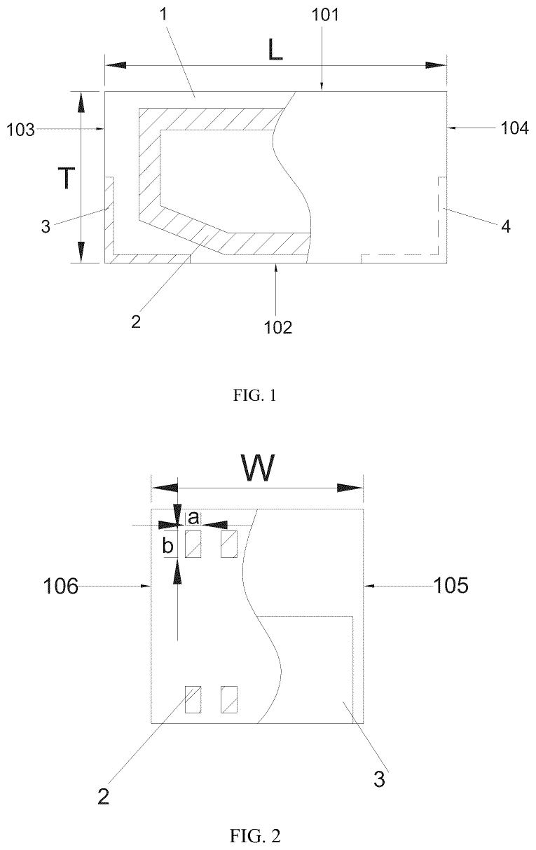

As shown in FIG. 1 and FIG. 2, in some embodiments, an electronic device includes a blank 1 with an insulating material, a conductive coil 2 within the blank 1, and a first terminal 3 and a second terminal 4 exposed to a surface of the blank 1, The blank has a top surface 101, a bottom surface 102, a first lateral surface 103, a second lateral surface 104, a front surface 105 and a back surface 106. The top surface 101 is parallel to the bottom surface 102, the first lateral surface 103 is parallel to the second lateral surface 104, and the front surface 105 is parallel to the back surface 106. The plane parallel to the top surface 101 and the bottom surface 102, the plane parallel to the first lateral surface 103 and the second lateral surface 104, and the plane parallel to the front surface 105 and the back surface 106 are mutually perpendicular. The external dimensions of the top surface, the bottom surface, the first lateral surface, the second lateral surface, the front surface and the back surface are metric 0402 size or below, that is, a distance between the first lateral surface 103 and the second lateral surface 104 is 0.42 mm or less, a distance between the front surface 105 and back surface 106 is 0.22 mm or less, and a distance between the top surface 101 and the bottom surface 102 is 0.22 mm or less. The conductive coil 2 can have a plurality of electrode layers. Exemplarily, an electrode layer of the conductive coil 2 correspondingly connected to the first terminal 3 is a lead-in layer electrode, an electrode layer of the conductive coil 2 correspondingly connected to the second terminal 4 is a lead-out layer electrode, an electrode layer of the conductive coil 2 located between the lead-in layer electrode and the lead-out layer electrode is an intermediate layer electrode, and respective electrode layers are connected through conductive paths between layers. The cross section of at least one electrode layer of conductive coil 2 has a width in the range of 15 μm to 20 μm and a thickness in the range of 9 μm to 15 μm, and the thickness to width ratio is 0.5 or more.

In some embodiments, the thickness-to-width ratio of at least one electrode layer is 0.6 or more.

In some embodiments, the thickness-to-width ratio of at least one electrode layer is 2.0 or less.

In some embodiments, the thickness-to-width ratio of at least one electrode layer is 1.0 or less.

In some embodiments, the cross section of the electrode layer of the conductive coil 2 has a rectangular, trapezoidal, parallelogram or elliptical shape, and the thickness-to-width ratio of the electrode layer is the ratio of the maximum thickness of the cross section of the electrode layer to the maximum width of the cross section of the electrode layer.

In some embodiments, the electronic device is a laminated chip composite inductor device.

In some embodiments, at least one electrode layer refers to every electrode layer.

Embodiments of the electronic device are further described below.

As shown in FIGS. 1 to 2, the present embodiment provides an electronic device, the blank has the top surface 101, the bottom surface 102, the first lateral surface 103, the second lateral surface 104, the front surface 105, and the back surface 106. The top surface 101 is parallel to the bottom surface 102, the first lateral surface 103 is parallel to the second lateral surface 104, and the front surface 105 is parallel to the back surface 106. The plane parallel to the top surface 101 and the bottom surface 102, the plane parallel to the first lateral surface 103 and the second lateral surface 104, and the plane parallel to the front surface 105 and the back surface 106 are mutually perpendicular, and form an X, Y, and Z coordinate system. L in FIG. 1 represents the length of the electronic device, T represents the thickness of the electronic device, and W in FIG. 2 represents the width of the electronic device.

The electronic device has the blank 1 of insulating material, the conductive coil 2 and the first terminal 3, and the second lateral surface 104 has the symmetrical second terminal 4 to the first terminal 3 about the symmetrical plane which is the center plane of the first lateral surface 103 and the second lateral surface 104.

The conductive coil 2 of the electronic device has an electrode layer connected to the first terminal 3 and the second terminal 4, and according to the usage, the conductive coil electrode layer correspondingly connected to the terminal through which the signal flows into the electronic device is a lead-in layer, and the conductive coil electrode layer correspondingly connected to the terminal through which the signal flows out of the electronic device is a lead-out layer, and thereby an inductor coil conducted is formed.

The conductive coil has a lead-in layer electrode, a lead-out layer electrode and an intermediate layer electrode, and respective layer electrodes are connected through connection points between layers, thereby making the product physically conductive. Alternatively, a single electrode layer is connected with the first terminal 3 and the second terminal 4 to play the role of lead-in and lead-out and achieve a physical conductivity.

As shown in FIG. 2, the cross section of the electrode layer has a thickness of a, a width of b, and a thickness of a/width of b, i.e. the thickness-to-width ratio.

The product of the present embodiment is processed through production processes such as molding, cutting, glue discharging, sintering, chamfering and electroplating:

Molding: in the workshop, products are printed and stacked in a certain direction in a method of printing with a squeegee, so that products with a certain thickness are obtained.

Cutting: products printed and stacked to a certain thickness are slit according to specific dimensional requirements on length and width to be cut into sizes such as metric 0402 and metric 0201.

Glue discharging: product is placed on a tray and put into a glue discharging furnace, and organic system substances inside the product are discharged in the manner of heating and ventilation.

Sintering: product after glue discharging on the tray is put into a sintering furnace, and the product is densified in material and solidified in performance.

Chamfering: products after sintering are put into the chamfering tank and mixed operated with chamfering liquid, grinding medium, etc., and the edges and corners of the product are smoothened.

Electroplating: terminals on the exterior of the products are electroplated with nickel and tin layers, and the welding performance of the products are ensured.

The specific manufacturing method is as follows: preparing raw materials with specified composition, coating the raw materials onto a carrier plate with a squeegee to create a substrate, printing a conductive paste on the substrate, creating a conductive coil and terminals through exposure and development, printing a layer of printing ceramic paste on the conductive coil, creating a through hole through exposure and development, and after repeatedly manufacturing to a specified number of layers, cutting it with a cutter and making it singulated to create the body of the product. During manufacturing, the production platforms for the internal coil of the product includes two types: laminated printing and yellow light film, the coil is printed with a printer, and then cured and manufactured after light transmission from the pattern on the mask, and the width of the coil can be controlled by the pattern size on the mask and the degree of parallelism of the light rays.

The product body is placed in a firing oven, and treated with adhesive removal at a temperature of 465° C. in an atmospheric environment, and sintered at 900° C., and an inductor with electrical characteristics is thus obtained. Ni plating and Sn plating are sequentially formed on the surface of the terminals of the product through electroplating, and the external electrodes are finally obtained.

For the metric 0201 size 3.0 nH inductor product prepared with the aforementioned method, with other preparation parameters of the product being the same, the tested Q values for designs with different thickness-to-width ratios of the coil cross sections were compared, and as shown in Table 1, it can be seen that compared with the Q value for the design with a thickness-to-width ratio of 0.4, the Q value for the design with a thickness-to-width ratio of 0.5 can be increased by 10%, the Q value for the design with a thickness-to-width ratio of 0.6 can be increased by 12%, and the Q value for the design with a thickness-to-width ratio in the range of 0.7-1 can be increased by 16% or more. The Q value performance for the design with a thickness-to-width ratio in the range of 0.5-2 can be improved by 10% or more compared with that for the design with a thickness-to-width ratio of 0.4.

TABLE 1
the Metric 0201 size 3.0 nH Inductor Product

| | | | | L | Q | |
|---|---|---|---|---|---|---|
| | | | Thickness- | Value | Value | Increase Rate |
| Serial | Width | Thickness | to-width | (0.5 | (0.5 | Compared to |
| Number | (um) | (um) | Ratio | GHz) | GHz) | No. 1 |
| 1 | 20 | 8 | 0.4 | 3.01 | 15.22 | / |
| 2 | 20 | 9 | 0.5 | 3.01 | 16.71 | 10% |
| 3 | 18 | 10 | 0.6 | 2.99 | 17.03 | 12% |
| 4 | 17 | 12 | 0.7 | 2.96 | 17.67 | 16% |
| 5 | 16 | 13 | 0.8 | 2.95 | 17.86 | 17% |
| 6 | 16 | 14 | 0.9 | 2.99 | 18.13 | 19% |
| 7 | 15 | 15 | 1.0 | 2.95 | 18.1 | 19% |
| 8 | 15 | 22.5 | 1.5 | 2.96 | 18.03 | 18% |
| 9 | 15 | 25.5 | 1.7 | 2.95 | 17.96 | 18% |
| 10 | 15 | 30 | 2.0 | 2.95 | 17.55 | 15% |

For the metric 0402 size 2.0 nH inductor product prepared with the aforementioned method, with other preparation parameters of the product being the same, the tested Q values for designs with different thickness-to-width ratios of the coil cross sections were compared, and as shown in Table 2, it can be seen that compared with the Q value for the design with a thickness-to-width ratio of 0.4, the Q value for the design with a thickness-to-width ratio of 0.5 can be increased by 10%, and the Q value for the design with a thickness-to-width ratio in the range of 0.6-1 can be increased by 13% or more. The Q value performance for the design with a thickness-to-width ratio in the range of 0.5-2 can be improved by 10% or more compared with that for the design with a thickness-to-width ratio of 0.4.

TABLE 2
the Metric 0402 Size 2.0 nH Inductor Product

| | | | | L | Q | |
|---|---|---|---|---|---|---|
| | | | Thickness- | Value | Value | Increase Rate |
| Serial | Width | Thickness | to-width | (0.5 | (0.5 | Compared to |
| Number | (um) | (um) | Ratio | GHz) | GHz) | No. 1 |
| 1 | 25 | 9 | 0.4 | 1.98 | 18.64 | / |
| 2 | 20 | 10 | 0.5 | 2.03 | 20.43 | 10% |
| 3 | 18 | 11 | 0.6 | 2.04 | 21.05 | 13% |
| 4 | 18 | 12 | 0.7 | 1.97 | 21.23 | 14% |
| 5 | 18 | 14 | 0.8 | 1.95 | 21.54 | 16% |
| 6 | 17 | 15 | 0.9 | 1.94 | 21.59 | 16% |
| 7 | 16 | 16 | 1.0 | 1.94 | 21.72 | 17% |
| 8 | 15 | 22.5 | 1.5 | 1.93 | 21.63 | 16% |
| 9 | 15 | 25.5 | 1.7 | 1.94 | 21.5 | 15% |
| 10 | 13 | 26 | 2.0 | 1.93 | 21.31 | 14% |

The design of thickness-to-width ratio of coil cross section in the embodiment of the present application can increase the Q value of the inductor product with the same inductance value by 10% or more, so that the inductor product can do work more effectively and the sensitivity to the cross sectional width of the coil is reduced, that is, the electrical stability of the inductor product during the change in the cross-sectional width of the coil is improved, the failure rate caused by the electrical property difference between products is reduced, and the using experience of the product at the application end is improved.

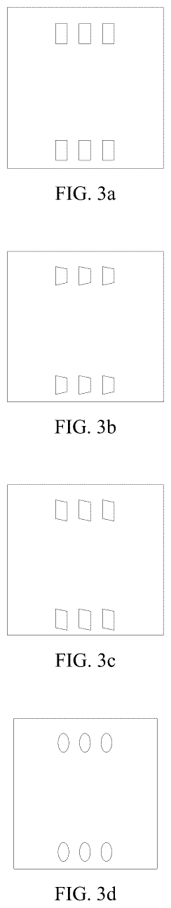

As shown in FIGS. 3a to 3d, the electronic device of the embodiment of the present application is applicable not only to inductor products with a thickness-to-width ratio for a rectangular coil cross section but also to inductor products with thickness-to-width ratios for other non-rectangular coil cross sections.

The background section of the present application may contain background information about the problem or environment of the present application, and is not necessarily a description of the prior art. Therefore, the content included in the background section is not an admission by the applicant of the prior art.

The above content is a further detailed description of the present application in combination with specific/preferred embodiments, and it cannot be construed that the specific implementation of the present application is limited to these descriptions. For those ordinary skilled in the art to which the present application pertains, without departing from the concept of the present application, several substitutions or modifications can be made to these described embodiments, and these substitutions or modifications should be regarded as fall within the scope of protection of the present application. In the description of this specification, references to terms such as “an embodiment”, “some embodiments”, “a preferred embodiment”, “an example”, “a specific example”, or “some examples” indicate that the specific features, structures, materials, or characteristics described in conjunction with the embodiment or example are included in at least one embodiment or example of the present application. In this specification, the illustrative expressions of the aforementioned terms do not necessarily target the same embodiment or example. Furthermore, the specific features, structures, materials, or characteristics described can be combined in any one or more embodiments or examples in a suitable manner. Without contradiction, those skilled in the art can combine and integrate different embodiments or examples, as well as features of different embodiments or examples, described in this specification. Although the embodiments of the present invention and their advantages have been described in detail, it should be understood that various changes, substitutions and modifications can be made herein without departing from the scope of protection of the present application.

What is claimed is:

1. An electronic device, comprising a blank with an insulating material, a conductive coil within the blank, and a first terminal and a second terminal exposed to a surface of the blank, wherein
the blank has a top surface, a bottom surface, a first lateral surface, a second lateral surface, a front surface and a back surface, the top surface is parallel to the bottom surface, the first lateral surface is parallel to the second lateral surface, the front surface is parallel to the back surface, and a plane parallel to the top surface and the bottom surface, a plane parallel to the first lateral surface and the second lateral surface, and a plane parallel to the front surface and the back surface are mutually perpendicular;
a distance between the first lateral surface and the second lateral surface is 0.42 mm or less, a distance between the front surface and back surface is 0.22 mm or less, and a distance between the top surface and the bottom surface is 0.22 mm or less; and
a thickness-to-width ratio of at least one electrode layer of the conductive coil is 0.5 or more, and a cross section of the at least one electrode layer has a width of at least 15 μm and at most 30 μm, and a thickness of at least 15 μm and at most 40 μm.

2. The electronic device according to claim 1, wherein the conductive coil has a plurality of electrode layers, an electrode layer of the conductive coil correspondingly connected to the first terminal is a lead-in layer electrode, an electrode layer of the conductive coil correspondingly connected to the second terminal is a lead-out layer electrode, an electrode layer of the conductive coil located between the lead-in layer electrode and the lead-out layer electrode is an intermediate layer electrode, and respective electrode layers are connected through conductive paths between layers.

3. The electronic device according to claim 2, wherein the thickness-to-width ratio of the at least one electrode layer is 0.6 or more.

4. The electronic device according to claim 3, wherein the thickness-to-width ratio of the at least one electrode layer is 2.0 or less.

5. The electronic device according to claim 4, wherein the thickness-to-width ratio of the at least one electrode layer is 1.0 or less.

6. The electronic device according to claim 5, wherein the cross section of the electrode layer of the conductive coil has a rectangular, trapezoidal, parallelogram or elliptical shape, and the thickness-to-width ratio of the electrode layer is a ratio of a maximum thickness of the cross section of the electrode layer to a maximum width of the cross section of the electrode layer.

7. The electronic device according to claim 6, wherein the electronic device is a laminated chip composite inductor device.

8. The electronic device according to claim 7, wherein the conductive coil is formed in a stack provided with a plurality of electrode layers, and the plurality of electrode layers form a spiral conductive coil by forming connections in a state of overlapping with each other when viewed from a stacking direction.

9. The electronic device according to claim 8, wherein the stacking direction is a direction perpendicular to the front surface and the back surface of the electronic device.

10. The electronic device according to claim 9, wherein a respective electrode layer of the plurality of electrode layers is provided perpendicular to the stacking direction.

11. The electronic device according to claim 10, wherein the first terminal comprises two portions perpendicular to each other, and the two portions of the first terminal are located on the first lateral surface and the bottom surface, respectively; and the second terminal comprises two portions perpendicular to each other, and the two portions of the second terminal are located on the second lateral surface and the bottom surface, respectively.

12. The electronic device according to claim 2, wherein the at least one electrode layer is an intermediate layer electrode.

13. The electronic device according to claim 3, wherein the at least one electrode layer is an intermediate layer electrode.

14. The electronic device according to claim 4, wherein the at least one electrode layer is an intermediate layer electrode.

15. The electronic device according to claim 5, wherein the at least one electrode layer is an intermediate layer electrode.

16. The electronic device according to claim 6, wherein the at least one electrode layer is an intermediate layer electrode.

17. The electronic device according to claim 8, wherein the at least one electrode layer is an intermediate layer electrode.

18. The electronic device according to claim 9, wherein the at least one electrode layer is an intermediate layer electrode.

19. The electronic device according to claim 10, wherein the at least one electrode layer is an intermediate layer electrode.

20. The electronic device according to claim 11, wherein the at least one electrode layer is an intermediate layer electrode.
